(19) United States
(12) Patent Application Publication
(10) Pub. No.: US 2012/0154094 A1
(43) Pub. Date: Jun. 21, 2012

(54) TERMINAL ASSEMBLY FOR TRANSFORMER AND TRANSFORMER WITH TERMINAL ASSEMBLY

(76) Inventor: Martin Goertz, Wenzenbach (DE)

(21) Appl. No.: 13/376,985

(22) PCT Filed: Mar. 31, 2010
(86) PCT No.: PCT/EP2010/054307

§ 371 Date: Feb. 29, 2012

(30) Foreign Application Priority Data
Jun. 16, 2009 (EP) 09007869.2

(51) Int. Cl. H01F 27/29; H01R 13/02

(52) U.S. Cl. 336/192; 439/890

(57) ABSTRACT

The invention relates to a terminal assembly (10, 10′, 10″) for establishing electrical connection between at least one low voltage side coil terminal of a transformer (100) and at least one associated external supply connector. The terminal assembly (10, 10′, 10″) comprises at least one conductive connection element (12) for connecting to the at least one low voltage side coil terminal of the transformer (100) and to the at least one associated external supply connector and an insulating support plate (14) being mountable to the transformer and for positioning of the at least one conductive connection element (12) with respect to the at least one associated external supply connector. The at least one conductive connection element (12) is movably attached to the insulating support plate (14) so as to be movable within an extension area of the insulating support plate (14) along at least one reference direction. Furthermore, the invention relates to a transformer (100) having such a terminal assembly (10, 10′, 10″) attached thereto.

### FIELD OF THE INVENTION

The invention relates to a terminal assembly for establishing electrical connection between a low voltage side coil terminal of a transformer and an associated external supply connector and to a transformer having such a terminal assembly attached thereto.

### BACKGROUND ART

When a transformer is to be integrated in an existing electrical system, an electrical connection between at least one low voltage side coil terminal of the transformer and at least one associated external supply connector forming part of said electrical system, such as a power source connector, needs to be established. Such external supply connectors are commonly present in the form of prearranged busbar structures, wherein several busbars are disposed in predetermined positions and at predetermined intervals with respect to each other.

In order to enable an electrical connection between the busbars and the transformer terminals, it is known in the art to individually design the geometry of the transformer terminals according to the specific requirements of a given electrical system, i.e., to the particular arrangement of said busbars.

However, this approach requires a customised transformer terminal configuration, depending on the details of the connector structure of a given electrical system, thus leading to a rise in constructional effort as well as material costs.

Consequently, also the processing times both for assembling the transformer terminal structure and for attaching it to the transformer increase.

Another conventional approach of providing electrical connection between a transformer and the external supply connectors of a given electrical system relies on using cables for connecting the transformer terminals to the associated external supply connectors.

### SUMMARY OF THE INVENTION

It is an object of the invention to provide a terminal assembly for a transformer that allows for a simple and efficient electrical connection to at least one external supply connector and a transformer employing such a terminal assembly.

This goal is achieved by a terminal assembly with the technical features of claim 1 and a transformer with the technical features of claim 12. Preferred embodiments of the invention follow from the dependent claims.

The present invention provides a terminal assembly for establishing electrical connection between at least one low voltage side coil terminal of a transformer and at least one associated external supply connector. The terminal assembly comprises at least one conductive connection element for connecting to the at least one low voltage side coil terminal of the transformer and to the at least one associated external supply connector and an insulating support plate being mountable to the transformer and for positioning of the at least one conductive connection element with respect to the at least one associated external supply connector.

Herein, the at least one conductive connection element is movably attached to the insulating support plate so as to be movable within an extension area of the insulating support plate along at least one reference direction. The term “reference direction” as used herein refers to a direction with reference to the insulating support plate.

Said reference direction may, in general, be any direction and can be suitably chosen in view of the application area of the terminal assembly. In some embodiments it may be advantageous that the at least one conductive connection element be ..movably attached to the insulating support plate so as to be movable along two or more reference directions. The conductive connection element is preferably made of a metal, such as iron or, particularly preferably, copper.

While the at least one conductive connection element is movable within an extension area of the insulating support plate, it may be attached to the insulating support plate in such a way that its movement can further extend beyond said extension area.

Moreover, the at least one conductive connection element may also protrude beyond the extension area of the insulating support plate. The insulating support plate may have any conceivable shape and/or size, as long as it is mountable to a transformer and adapted for the movable attachment of at least one conductive connection element thereto.

The movable attachment of the at least one conductive connection element allows for it to be accurately positioned with respect to the at least one associated external supply connector. Hence, if a transformer that is equipped with the terminal assembly of the invention is to be integrated in a given electrical system, the position of said connection element can easily be adapted according to the specific connection requirements of said system, namely the exact position of a corresponding external supply connector associated with the system.

In this way, the necessity of providing a customised transformer terminal configuration for each electrical system with differing connector geometry is eliminated. Hence, the terminal assembly of the invention allows for a simple and efficient electrical connection between a transformer terminal and an external supply connector and can be employed for any type of external supply connector structure.

The manufacturing process for the transformer terminal assembly and the transformer is thus greatly simplified, consequently reducing both production time and costs.

Depending on the application area of the terminal assembly, it may comprise a plurality of conductive connection elements for connecting to a plurality of low voltage side coil terminals of the transformer and to a plurality of associated external supply connectors, the plurality of conductive connection elements being attached to the insulating support plate, wherein at least one of the plurality of conductive connection elements is movably attached to the insulating support plate so as to be movable within an extension area of the insulating support plate along at least one reference direction.

Such a terminal assembly can be used for integrating a transformer in an electrical system with a plurality of external supply connectors. It may further be advantageous that more than one, or possibly even all, of the conductive connection elements be movably attached to the insulating support plate so as to be movable within an extension area of the insulating support plate along at least one reference direction.

This configuration provides further freedom in arranging the conductive connection elements relative to the insulating support plate and ensures a reliable and efficient connection with any kind of external supply connector arrangement.

The terminal assembly of the invention can be employed particularly advantageously for high-power current or three-phase current systems where usually large-sized and heavy transformers are used and, due to the high currents flowing, the external supply connectors are generally formed so as to be thick in diameter and thus very rigid.

In one embodiment of the invention, the terminal assembly comprises at least one attachment member, wherein the at least one conductive connection element is attached to the insulating support plate via the at least one attachment member.

Said attachment member may have any conceivable shape and/or size and may be made of any conductive or non-conductive material, such as a metal or a plastic, as long as it is suitable for movably attaching the at least one conductive connection element to the insulating support plate. For example, the attachment member may be formed of a nut and a bolt which is inserted through corresponding openings in the conductive connection element and the insulating support plate.

On the other hand, the attachment member may also have a more complex structure, depending on the desired arrangement of the conductive connection element relative to the insulating support plate, and can, for instance, be formed as an angle bracket or the like.

In one embodiment, the terminal assembly comprises at least one fixing member, wherein the at least one conductive connection element is releasably fixable in its position within the extension area of the insulating support plate by the at least one fixing member.

However, the conductive connection element may further be releasably fixable by said fixing member in a position that lies beyond said extension area, depending on the details of the attachment of the conductive connection element to the insulating support plate. Such a fixing member allows for the at least one conductive connection element to be reliably secured in its position, once it has been arranged so as to match the position of the associated external supply connector.

The fixing member thus provides a particularly robust and stable configuration of the terminal assembly when being used for electrically connecting a transformer. There are no particular material requirements for the fixing member, which may, for instance, be made of a metal or a plastic, as long it is strong enough to reliably retain the conductive connection element in its position.

In some embodiments, the fixing member may, for example, be a bolt and a nut, a clamp or a bracket, which can be loosened, so as to allow the conductive connection element to be moved relative to the insulating support plate, and subsequently tightened, in order to fix the conductive connection element in place when it has been arranged in a desired position.

It is further conceivable that one and the same element be used as both the attachment member and the fixing member, thus allowing for a particularly simple configuration of the terminal assembly.

In one embodiment, the insulating support plate has a planar shape and/or the at least one conductive connection element has a planar shape. If both the insulating support plate and the at least one conductive connection element have a planar shape, they may be disposed so that their planes form any desired angle between them.

In one embodiment the insulating support plate and the at least one conductive connection element are arranged in such a way that the plane of the insulating support plate is perpendicular to the plane of the at least one conductive connection element.

In this case, the relative alignment of conductive connection element and insulating support plate may, for instance, be such that a side edge of the conductive connection element faces the plane of the insulating support plate or such that a side edge of the insulating support plate faces the plane of the conductive connection element. For both arrangements, for example, a suitable angle bracket could be used as an attachment member.

Moreover, the insulating support plate and the at least one conductive connection element may be arranged in such a way that the plane of the insulating support plate is parallel to the plane of the at least one conductive connection element. For this configuration, a nut and a bolt, being inserted through corresponding openings in the conductive connection element and the insulating support plate, could be advantageously used as both attachment and fixing member, yielding a particularly simple configuration of the terminal assembly.

In one embodiment of the invention, the insulating support plate has an elongated opening, such as a slot or the like, along which the at least one conductive connection element is movable. In other words, the longitudinal direction of the elongated opening is aligned along the at least one reference direction.

For instance, if a nut and a bolt serve as an attachment and possibly also fixing member, the bolt can be inserted through the elongated opening and a corresponding opening in the conductive connection element, as has been described in detail above. The insulating support plate may also have two or more elongated openings, which may be arranged in parallel or at an angle with each other.

In the case of two or more parallel elongated openings, if, for example, a plurality of nuts and bolts is used as attachment and possibly also fixing members in the way detailed above, a particularly stable configuration of the terminal assembly can be provided, reliably preventing any rotational movement of the at least one conductive connection element about an axis perpendicular to the extension area of the insulating support plate.

Furthermore, the insulating support plate may be provided with a grid of regularly arranged through holes. These through holes may be used for attaching the at least one conductive connection element, for example in the manner detailed above, using a nut and a bolt. The insulating support plate may also be configured so as to include a grid of regularly arranged through holes as well as at least one elongated opening.

Furthermore, also the conductive connection element may be provided with a grid of regularly arranged through holes which can serve for attachment to the insulating support plate and/or for connection to the at least one low voltage side coil terminal of the transformer and/or the at least one associated external supply connector.

In one embodiment of the invention, the terminal assembly comprises at least one flexible conductive member, such as a cable, a wire or the like, which has one end electrically connected to the at least one conductive connection element and the other end connectable to the low voltage side coil terminal of the transformer. The electrical connection between the at least one flexible conductive member and the at least one conductive connection element may be established in any conceivable manner, such a by welding or by using a cable lug, a clamp, a bracket or the like.

The insulating support plate is preferably made of a material with suitable electrical and mechanical properties. For instance, the insulating support plate may be made of plastic, preferably of GPO3 or HM 2471. In this way, a light-weight and easy to produce support plate with good insulating properties and a high degree of robustness can be provided.

The invention further provides a transformer with a terminal assembly as described above attached thereto. The terminal assembly may be permanently or detachably attached to the transformer in any conceivable way, such as by screwing, clamping, gluing or the like, and in any desired position, e.g., at a front end, a rear end, a side end or a top end of the transformer, depending on the configuration of the external supply connectors and the space requirements of an electrical system. The advantages such a transformer offers for integration in a given electrical system have been discussed in detail above.

In one embodiment of the invention, the terminal assembly is movably attached to the transformer so as to be movable along at least one reference direction with respect to the transformer. Such a configuration provides further freedom in arranging the conductive connection elements with respect to the transformer and ensures a reliable and efficient connection with any kind of external supply connector arrangement.

The terminal assembly may further comprise at least one flexible conductive member, such as a cable, a wire or the like, which has one end electrically connected to the at least one conductive connection element and the other end electrically connected to a related low voltage side coil terminal of the transformer. The electrical connection between the at least one flexible conductive member and the at least one conductive connection element as well as the electrical connection between the at least one flexible conductive member and the related low voltage side coil terminal of the transformer may be established in any conceivable manner, such a by welding or by using a cable lug, a clamp, a bracket or the like.

In one embodiment of the invention, the transformer is a dry-type transformer, i.e., a transformer that does not use any cooling liquid for dissipating the heat generated by the coils. Such transformers have the advantage over liquid-filled transformers of a simple configuration and are further preferable in view of environmental considerations.

### BRIEF DESCRIPTION OF THE DRAWINGS

Hereinafter, non-limiting examples of the terminal assembly and the transformer according to the invention are explained with reference to the drawings, in which:

FIG. 1 shows a perspective view of a transformer having two terminal assemblies according to a first embodiment of the invention attached thereto;

FIG. 2 shows a perspective view of a terminal assembly according to the first embodiment of the invention;

FIG. 3 shows a perspective view of a terminal assembly according to a second embodiment of the invention; and

FIG. 4 shows a perspective view of a terminal assembly according to a third embodiment of the invention.

### DETAILED DESCRIPTION OF CURRENTLY PREFERRED EMBODIMENTS

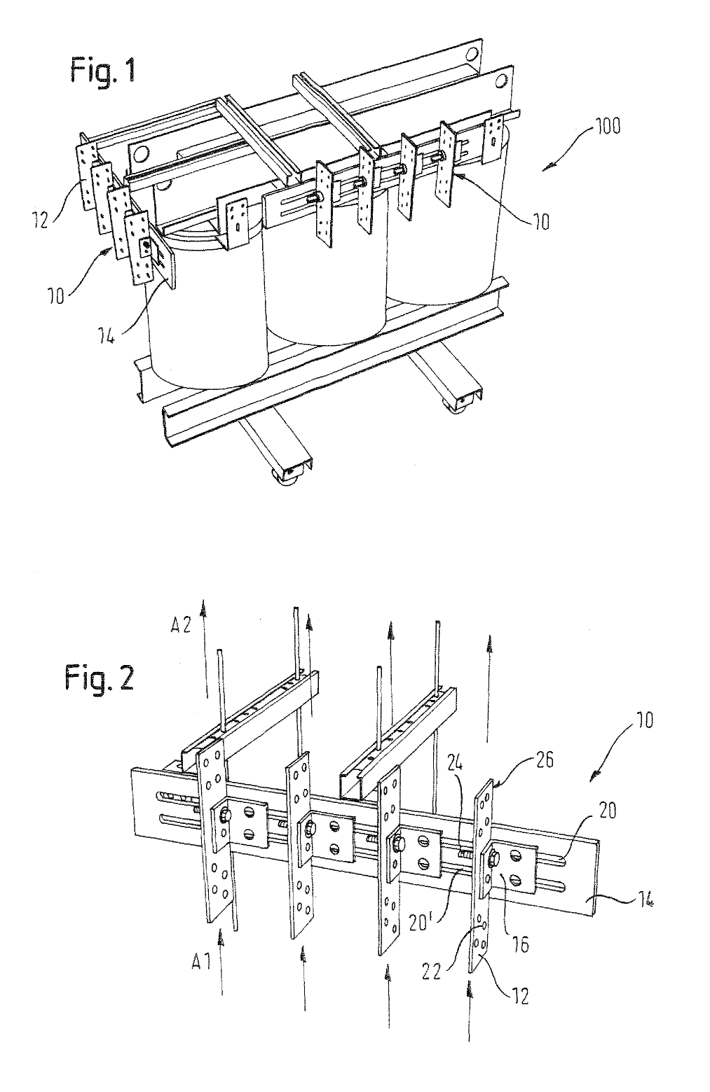

FIG. 1 shows a perspective view of a transformer 100 having two terminal assemblies 10 according to a first embodiment of the invention attached thereto. The terminal assemblies 10 are mounted to a front end and a side end of the transformer 100, respectively, with the use of screws which are not shown in FIG. 1.

As is shown in FIG. 2, the terminal assembly 10 comprises a planar-shaped insulating support plate 14 with two elongated openings 20, 20′, a plurality of planar-shaped conductive connection elements 12, each having a grid of regularly arranged through holes 22, a plurality of angle brackets 16, a plurality of first screws 24 and a plurality of second screws 18, see FIG. 4.

The conductive connection elements 12 are mounted to one end of the angle brackets 16 with the use of the first screws 24, which are respectively inserted through one of the through holes 22 and a corresponding opening in the angle bracket 16 and secured in place with a first nut (not shown in FIG. 2). The other end of the angle brackets 16 is mounted to the insulating support plate 14 by inserting the second screws 18 through the elongated openings 20, 20′ and corresponding openings in the angle brackets 16 and securing them in place with a plurality of second nuts (not shown in FIG. 2).

Hence, the angle brackets 16, the first screws 24, the second screws 18 and the first and second nuts form attachment members of the present embodiment. Moreover, the second screws 18 and the second nuts also serve as fixing members. Since the two parallel elongated openings 20, 20′ of the insulating support plate 14 are used for attaching the angle brackets 16 thereto, any rotational movement of the angle brackets 16, and consequently also the conductive connection elements 12, about an axis perpendicular to the plane of the insulating support plate 14 can be reliably prevented.

As shown in FIG. 2, the conductive connection elements 12 are attached to the insulating support plate 14 in such a way that their planes are perpendicular to the plane of the insulating support plate 14 and a side edge 26 of each conductive connection element 12 faces the plane of the insulating support plate 14. The conductive connection elements 12 are made of copper, the angle brackets 16 are made of iron and the insulating support plate 14 is made of GPO3.

An electrical connection between the conductive connection elements 12 and corresponding low voltage side coil terminals of the transformer 100 is established with the use of cables (not shown in FIG. 1). Each of these cables has one end thereof electrically connected to one of the conductive connection elements 12 and the other end thereof electrically connected to a related low voltage side coil terminal of the transformer 100, wherein both electrical connections are achieved with the use of cable lugs, screws and nuts.

Specifically, the one end of each cable is electrically connected and attached to a corresponding conductive connection element 12 by inserting a screw through one of the through holes 22 and an opening of the cable lug and securing said screw in place with a nut.

Herein, the cable ends may be attached to the lower parts of the conductive connection elements 12, as is indicated by arrows A1 in FIG. 2, or to any other desired parts of the conductive connection elements 12, such as the upper parts thereof. Instead of using one respective cable for each electrical connection between a conductive connection element 12 and a corresponding low voltage side coil terminal of the transformer 100, also a plurality of cables may be employed, depending on the size of the current flow between these elements.

If the transformer 100 of the present embodiment is to be integrated in a given electrical system, the following steps are carried out. First, the transformer 100 is placed in a desired position in the vicinity of the external supply connectors of the system. Then, the second screws 18 of the terminal assembly 10 are loosened, so as to allow the conductive connection elements 12 to be slid along the extension direction of the elongated openings 20, 20′.

By appropriately moving the conductive connection elements 12 relative to the insulating support plate 14, they can be arranged in such a way as to match the respective positions of the external supply connectors. After the conductive connection elements 12 have been placed in their desired positions, the second screws 18 are tightened in order to provide a stable and robust terminal configuration.

In this state, the conductive connection elements 12 can be electrically connected to the external supply connectors, for example by welding. Herein, the external supply connectors may be connected to any desired parts of the respective conductive connection elements 12, e.g., the upper parts thereof, as is indicated by arrows A2 in FIG. 2.

Hence, the terminal assembly 10 of the present embodiment provides a simple and efficient way of establishing an electrical connection with any kind of external supply connector arrangement. The position of the conductive connection elements 12 can be individually adjusted according to the requirements of a given electrical systems, thus eliminating the need for customised transformer terminal arrangements.

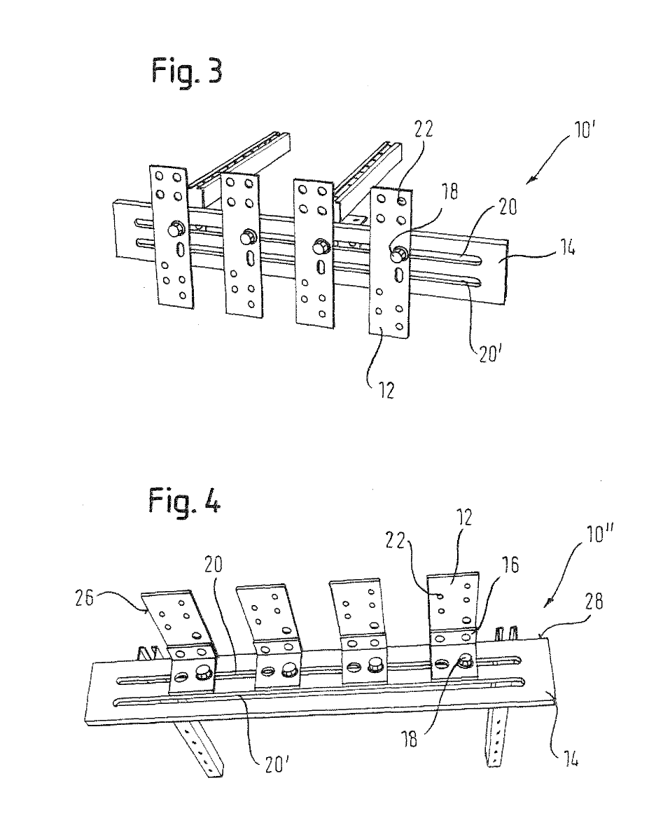

FIG. 3 shows a perspective view of a terminal assembly 10′ according to a second embodiment of the invention. The general structure of the terminal assembly 10′ is similar to that of the terminal structure 10 of the first embodiment shown in FIG. 2.

However, in contrast to the first embodiment, the terminal assembly 10′ of the second embodiment does not comprise a plurality of angle brackets 16 or first screws 24 and nuts, see FIG. 2, but only a plurality of second screws 18 and nuts (not shown in FIG. 3) which serve both as attachment and fixing members.

Although in FIG. 3 only second screws 18 inserted through the elongated opening 20 and corresponding through holes 22 of the conductive connection elements 12 are shown, another row of second screws 18 may be provided by inserting them through the elongated opening 20′ and corresponding through holes 22. The conductive connection elements 12 are movable along the extension direction of the elongated openings 20, 20′ when the second screws 18 are loosened and fixed in their positions when the second screws 28 are tightened, respectively.

A further difference between the terminal assembly 10′ of the second embodiment and that of the first embodiment is that the conductive connection elements 12 are arranged in such a way that their planes are parallel to the plane of the insulating support plate 14. The terminal assembly 10′ has a particularly simple configuration and can be used in the same way as described above for the first embodiment, offering the same advantages.

FIG. 4 shows a perspective view of a terminal assembly 10″ according to a third embodiment of the invention. The general structure of the terminal assembly 10″ is similar to that of the terminal structure 10 of the first embodiment, also comprising a plurality of angle brackets 16, a plurality of first screws 24, see FIG. 2, and a plurality of second screws 18, which are respectively secured by first and second nuts (not shown in FIG. 4). While the angle brackets 16, the first screws 24, the second screws 18 and the first and second nuts form attachment members, the second screws 18 and the second nuts also serve as fixing members.

As shown in FIG. 4, the conductive connection elements 12 are attached to the insulating support plate 14 in such a way that their planes are perpendicular to the plane of the insulating support plate 14, as in the case of the terminal assembly 10 of the first embodiment.

However, the relative arrangement of the conductive connection elements 12 and the insulating support plate 14 of the terminal assembly 10″ of the third embodiment differs from the geometry shown in FIG. 2 in that a side edge 28 of the insulating support plate 14 faces the planes of the conductive connection elements 12. The terminal assembly 10″ is thus particularly suitable for attachment to the top end of a transformer 100. The terminal assembly 10″ can be used in the same way as described above for the first embodiment and offers the same advantages.

The choice of the exact position on the transformer 100, such as a side end, the front end, the rear end or the top end thereof, for attaching the terminal assembly 10, 10′, 10″ of the invention thereto predominantly depends on the external supply connector arrangement and the space requirements of a given electrical system.

1. A terminal assembly (10, 10′, 10″) for establishing electrical connection between at least one low voltage side coil terminal of a transformer (100) and at least one associated external supply connector, the terminal assembly (10, 10′, 10″) comprising:
at least one conductive connection element (12) for connecting to the at least one low voltage side coil terminal of the transformer (100) and to the at least one associated external supply connector; and
an insulating support plate (14) being mountable to the transformer and for positioning of the at least one conductive connection element (12) with respect to the at least one associated external supply connector;
wherein the at least one conductive connection element (12) is movably attached to the insulating support plate (14) so as to be movable within an extension area of the insulating support plate (14) along at least one reference direction.

2. The terminal assembly (10, 10′, 10″) according to claim 1, characterised in that it comprises at least one attachment member (16, 18, 24), wherein the at least one conductive connection element (12) is attached to the insulating support plate (14) via the at least one attachment member (16, 18, 24).

3. The terminal assembly (10, 10′, 10″) according to claim 1 or 2, characterised in that it comprises at least one fixing member (18), wherein the at least one conductive connection element (12) is releasably fixable in its position within the extension area of the insulating support plate (14) by the at least one fixing member (18).

4. The terminal assembly (10, 10′, 10″) according to any one of the preceding claims, characterised in that the insulating support plate (14) has a planar shape and/or the at least one conductive connection element (12) has a planar shape.

5. The terminal assembly (10, 10″) according to claim 4, characterised in that the plane of the insulating support plate (14) is perpendicular to the plane of the at least one conductive connection element (12).

6. The terminal assembly (10′) according to claim 4, characterised in that the plane of the insulating support plate (14) is parallel to the plane of the at least one conductive connection element (12).

7. The terminal assembly (10, 10′, 10″) according to any one of the preceding claims, characterised in that the insulating support plate (14) has an elongated opening (20) along which the at least one conductive connection element (12) is movable.

8. The terminal assembly (10, 10′, 10″) according to any one of the preceding claims, characterised in that the insulating support plate (14) is provided with a grid of regularly arranged through holes.

9. The terminal assembly (10, 10′, 10″) according to any one of the preceding claims, characterised in that it comprises at least one flexible conductive member which has one end electrically connected to the at least one conductive connection element (12) and the other end connectable to the low voltage side coil terminal of the transformer (100).

10. The terminal assembly (10, 10′, 10″) according to any one of the preceding claims, characterised in that the insulating support plate (14) is made of GPO3 or HM 2471.

11. The terminal assembly (10, 10′, 10″) according to any one of the preceding claims, characterised in that it comprises a plurality of conductive connection elements (12) for connecting a plurality of low voltage side coil terminals of the transformer (100) to a plurality of associated external supply connectors, the plurality of conductive connection elements (12) being attached to the insulating support plate (14), wherein the plurality of the conductive connection elements (12) is movably attached to the insulating support plate (14) so as to be movable within an extension area of the insulating support plate (14) along at least one direction.

12. A transformer (100) with the terminal assembly (10, 10′, 10″) according to any one of claims 1 to 11 attached thereto.

13. The transformer (100) according to claim 12, characterised in that the terminal assembly 10, 10′, 10″) is movably attached to the transformer (100) so as to be movable along at least one reference direction with respect to the transformer (100).

14. The transformer (100) according to claim 12 or 13, characterised in that the terminal assembly (10, 10′, 10″) further comprises at least one flexible conductive member which has one end electrically connected to the at least one conductive connection element (12) and the other end electrically connected to a related low voltage side coil terminal of the transformer (100).

15. The transformer (100) according to any one of claims 12 to 14, characterised in that the transformer (100) is a dry-type transformer.
